(19) United States
(12) Patent Application Publication
(10) Pub. No.: US 2013/0280025 A1
(43) Pub. Date: Oct. 24, 2013

(54) VEHICLE RECOVERY ASSEMBLY

(71) Applicant: Alan John Puddephatt, Gerrards Cross (GB)

(72) Inventor: Alan John Puddephatt, Gerrards Cross (GB)

(73) Assignee: EKA Limited, Gerrards Cross (GB)

(21) Appl. No.: 13/883,493

(22) PCT Filed: Oct. 25, 2011
(86) PCT No.: PCT/GB2011/001534

§ 371 Date: Jul. 3, 2013

(30) Foreign Application Priority Data
Nov. 3, 2010 (GB) 1018577.5

(51) Int. Cl. B60P 3/12; B60S 9/04

(52) U.S. Cl. CPC B60P 3/125; B60S 9/04
USPC 414/800; 280/764.1; 280/415.1

(57) ABSTRACT

The invention disclosed herein relates to a vehicle recovery assembly (10) comprising a movable beam (20) carrying a recovery bar (50), wherein the bar (50) carries at least one spade (61, 62) to enable recovery of a vehicle. The recovery assembly (10) is capable of rescuing incapacitated or upturned vehicles, winching the incapacitated vehicle to partially recover it, followed by towing the partially recovered vehicle until it is fully recovered. The compact size of the vehicle recovery assembly enables it to be attached to small recovery vehicles, thus facilitating vehicle recovery in confined spaces.

The present invention relates to recovery vehicles, and in particular to an assembly for a recovery vehicle.

### BACKGROUND

During the course of moving in rough terrain, such as in a war zone for example, vehicles often encounter hazards that can result in a vehicle having to move off-road. As a result, the vehicle can end up falling into a ditch or trench or becoming bogged in soft ground. Once immobilised, the vehicle is trapped and is not able to recover on its own. In such situations, rescue vehicles are brought in to retrieve the trapped casualty vehicle.

Similar problems can occur when a vehicle is struck by an enemy device and ends up on its side or is otherwise incapacitated.

Rescue vehicles are commonly fitted with several devices that include a winch and a tow bar. These devices are attached to the casualty vehicle to facilitate recovery. Due to the weight of the vehicle to be rescued, the recovery vehicle is fitted with means to stabilise and anchor itself during the rescue operation. These means often include spades which are lowered into the ground before the rescue operation commences. The spades are usually attached to hydraulic rams to assist in driving the spades into the ground. Such a prior art device is known from WO 01/81137.

After the rescue vehicle is secured, the winch rope, either directly or via a pulley block is attached to the casualty vehicle to drag it to a point where it can be towed away. During this winching operation, the weight of the casualty vehicle as expressed by the pull on the winch rope is countered by the spades on the recovery vehicle that have been driven into the ground. Once on the road surface, the rescue vehicle can be attached to the casualty vehicle, thereby enabling the rescue vehicle to pull the casualty vehicle away for repair and maintenance.

Due to the nature of casualty vehicles and the forces involved during rescue operations, recovery vehicles are often large and weighted structures so as to provide sufficient ballast to counteract the weight of a casualty vehicle. The size of these recovery vehicles severely limits rescue operations in restricted and urban locations where access is difficult. Currently rescue operations for casualty vehicles in these terrains often involve other rescue means such as air evacuation.

Small towing vehicles are currently available for on-road towing operations, but these have until now not been suitable for more complex recovery operations. Accordingly, there is a need for a recovery assembly to fit smaller recovery vehicles such that difficult locations will be accessible, thus enabling rescue of casualty vehicles in these terrains.

### STATEMENT OF INVENTION

The present invention relates to a vehicle recovery assembly comprising a movable beam carrying a recovery bar, wherein the bar carries at least one spade to enable recovery of a vehicle. The present invention also relates to a recovery vehicle with a recovery assembly capable of rescuing incapacitated or upturned vehicles. The vehicle recovery assembly is capable of winching the incapacitated vehicle to partially recover it, followed by towing the partially recovered vehicle until it is fully recovered. The compact size of the recovery assembly enables it to be mounted on small recovery vehicles.

In one aspect of the present invention, the recovery assembly also comprises a bracket connected to a distal end of the beam via a first pivot to enable rotation of the beam about the first pivot axis. In another aspect of the present invention, the bracket is also connected to the recovery bar via a second pivot to enable rotation of the recovery bar about the second pivot axis. In a further aspect of the invention, at least one spade is removable to increase the functionality of the vehicle recovery assembly. In yet another aspect of the invention, the recovery bar rotates freely about the second pivot axis.

Yet another aspect of the present invention relates to a recovery assembly comprising a beam, a proximal end of which is securable to the carriage of a vehicle, and a bracket connected to a distal end of the beam via a first pivot enabling rotation of the bracket about the first pivot axis, the bracket further connected to a recovery bar via a second pivot enabling rotation of the recovery bar about the second pivot axis. In some aspects of the invention, the first pivot axis and second pivot axis are inclined to each other. In other aspects of the invention, the bracket is rotated about the beam by hydraulic means. In still further aspects of the present invention, the recovery bar rotates freely about the second pivot axis. In other aspects of the invention, the recovery bar carries at least one spade for engaging the ground when the recovery bar is lowered during a winching operation to enable a rescue operation. In certain aspects of the present invention, the recovery bar carries at least one adaptor for engaging a casualty vehicle during a towing operation.

One further aspect of the present invention relates to a method of recovering a vehicle incorporating applying removable spades to a recovery bar, driving the bar towards the ground such that the spades engage the ground, applying a winch rope to a vehicle to be recovered, and recovering the vehicle. In other aspects of the present invention, the method also comprises removing the spades from the recovery bar, applying towing adaptors to the recovery bar, and fully recovering the vehicle.

### BRIEF DESCRIPTION OF THE DRAWINGS

A specific embodiment of the present invention is now described with reference to the accompanying drawings, in which:

FIG. 1A is a perspective view of a rescue vehicle fitted with a vehicle recovery assembly in accordance with the present invention;

FIG. 1B is a perspective view of a vehicle recovery assembly in accordance with the present invention;

FIG. 2 is a detailed schematic view of part of the rescue vehicle assembly fitted with spades that engage the ground during a rescue operation;

FIG. 3A is a side view of the rescue vehicle assembly with the recovery bar in a stored position;

FIG. 3B is a side view of the rescue vehicle assembly with the recovery bar in an extended position;

FIG. 4 is a side view of the rescue vehicle assembly with spades attached to the recovery bar;

FIG. 5 is a side view of the rescue vehicle assembly with the spades engaging the ground during a rescue operation;

FIG. 6 is a side view of a rescue vehicle fitted with the rescue vehicle assembly when winching an off-road casualty vehicle while the spades stabilise the rescue vehicle;

FIG. 7 is a side view of the rescue vehicle assembly tow adaptors attached to the recovery bar; and

FIG. 8 is a side view of a rescue vehicle fitted with the rescue vehicle assembly when towing a casualty vehicle attached to the recovery bar via tow adaptors.

### DETAILED DESCRIPTION OF EMBODIMENTS

The present invention facilitates re-configuration of light vehicles to enable them to recover small casualty vehicles by adapting them with a rescue assembly. These light recovery vehicles are particularly desirable for vehicle recovery in rough or tricky terrain (such as a ditch, ravine or trench), or locations with difficult or limited access, that would not be accessible to larger conventional recovery vehicles.

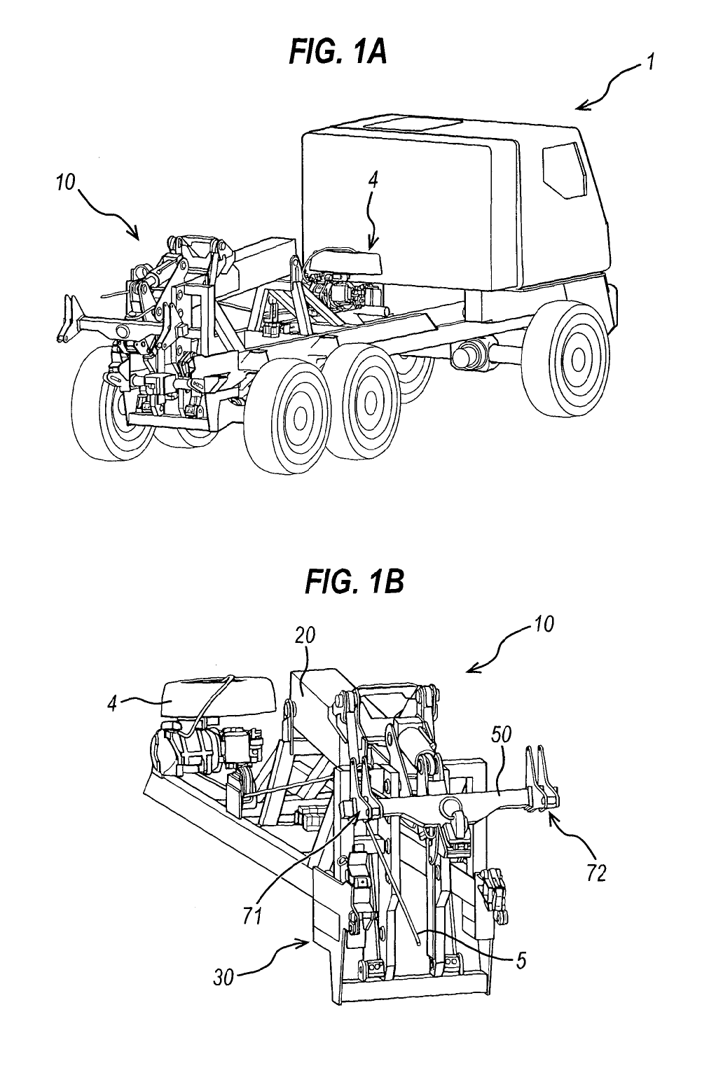

FIGS. 1 to 8 depict various configurations of the vehicle recovery assembly when attached to a light rescue vehicle. It should be noted that although two recovery spades (61, 62) are shown as part of the recovery assembly (10), one or more spades can be used for recovery. FIG. 1A is a perspective view of a recovery (or rescue) vehicle (1) fitted with a recovery assembly (10) in accordance with the present invention. A perspective view of the assembly (10) when mounted on the chassis of a recovery vehicle is shown in FIG. 1B.

The vehicle recovery assembly (10) comprises a hydraulically extendible moveable beam (20) pivoted in the vertical plane to the front end of the recovery assembly subframe (30). This subframe is attached to the chassis of the vehicle (1). A recovery bar (50) is attached to the moveable beam (20) by means of a bracket (40). More specifically, the bracket (40) is attached to the distal end of beam (20) via a first pivot (23), and the bracket is attached to the recovery bar (50) via a second pivot (41), where the first and second pivot axes are inclined to each other, preferably orthogonally. The first pivot (23) enables rotation of the recovery bar (50) about the first pivot axis (which is substantially parallel to the ground, in use) while the second pivot (41) enables rotation of the recovery bar (50) about the second pivot axis. A hydraulic system (24) is attached to both the beam (20) and the bracket (40) to facilitate movement of the bracket about the distal end of the beam (20). Thus the beam (20) and the bracket (40) move in a first plane and the recovery bar (50) rotates free about the second pivot axis in a second plane where the first and second planes are preferably orthogonally orientated.

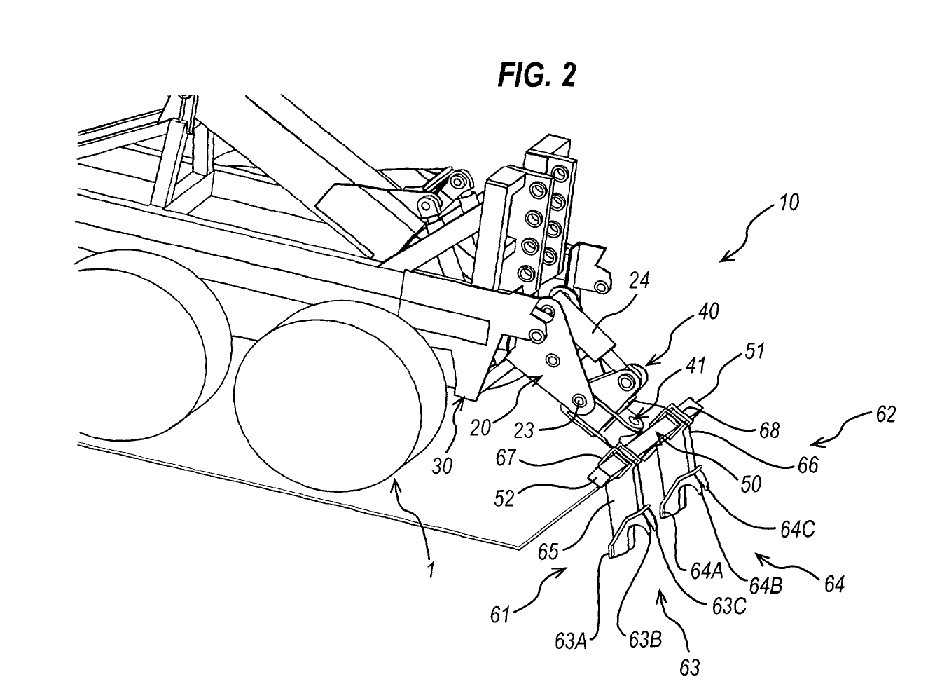

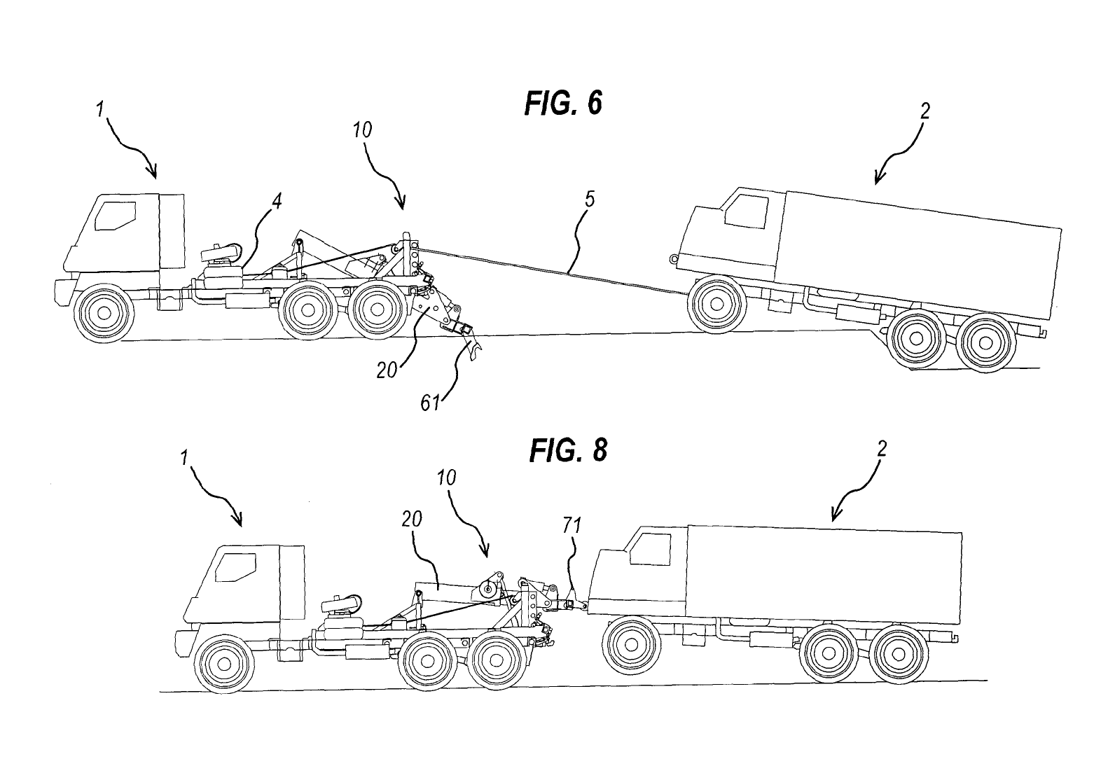

The recovery bar (50) is fitted with at least one removable spade (61, 62) as shown in FIGS. 2, 4, 5 and 6, or at least one tow adaptor (71, 72) as shown in FIGS. 1A, 1B, 7 and 8. It should be noted that while two spades are illustrated in the recovery assembly of FIG. 2, the invention disclosed herein can function with one or more spades. The same applies to the two adaptors shown in FIG. 7. The removable spades (61, 62) and the tow adaptors (71, 72) can be stowed in the recovery vehicle when not in use. The recovery vehicle also holds a winching apparatus (4), the details of which are not disclosed here for the sake of brevity.

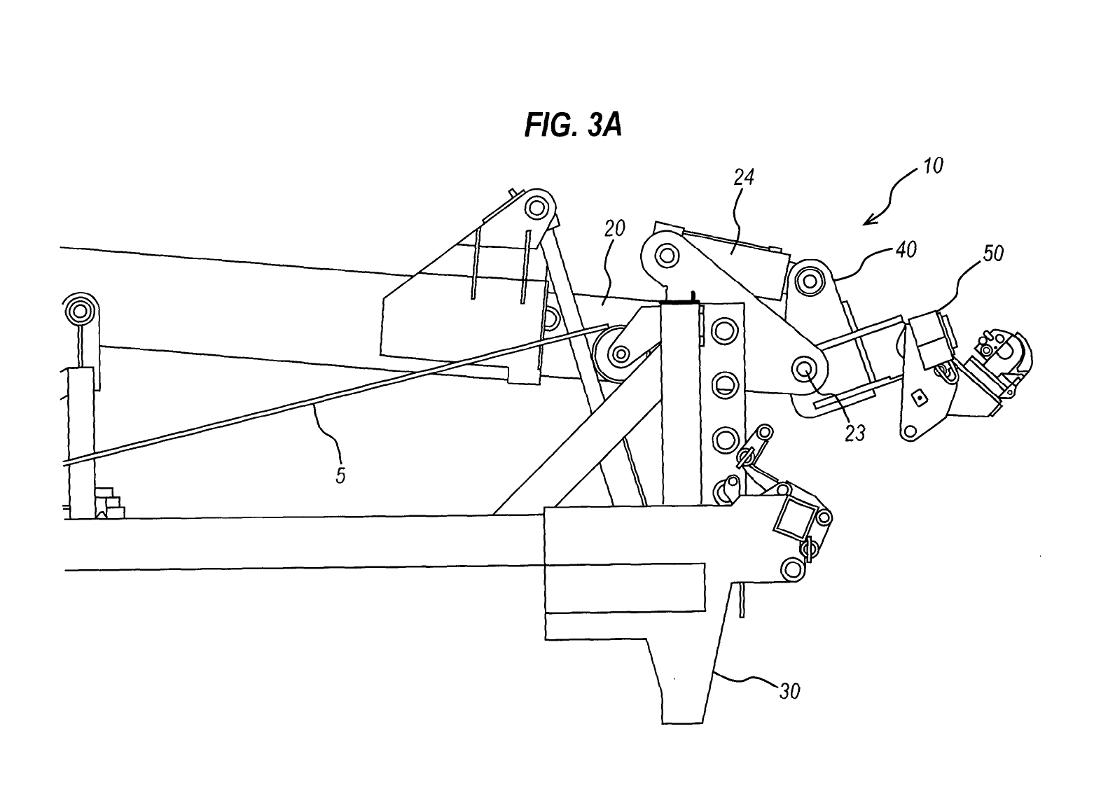

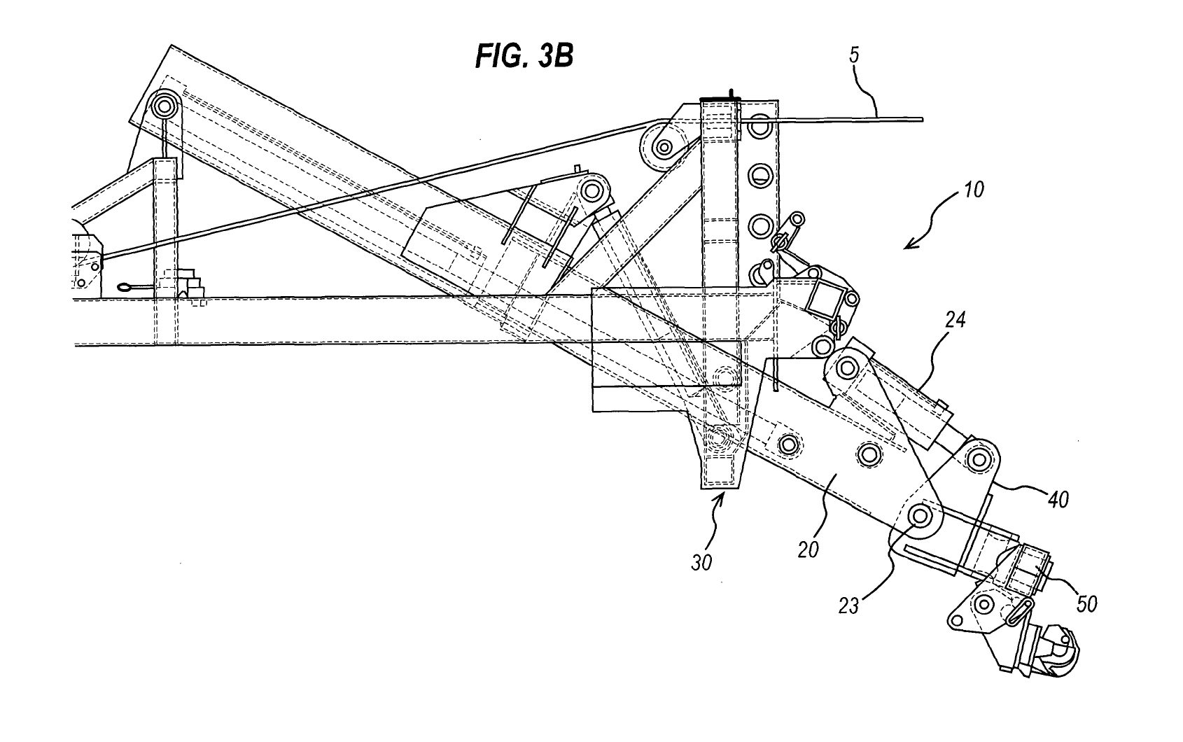

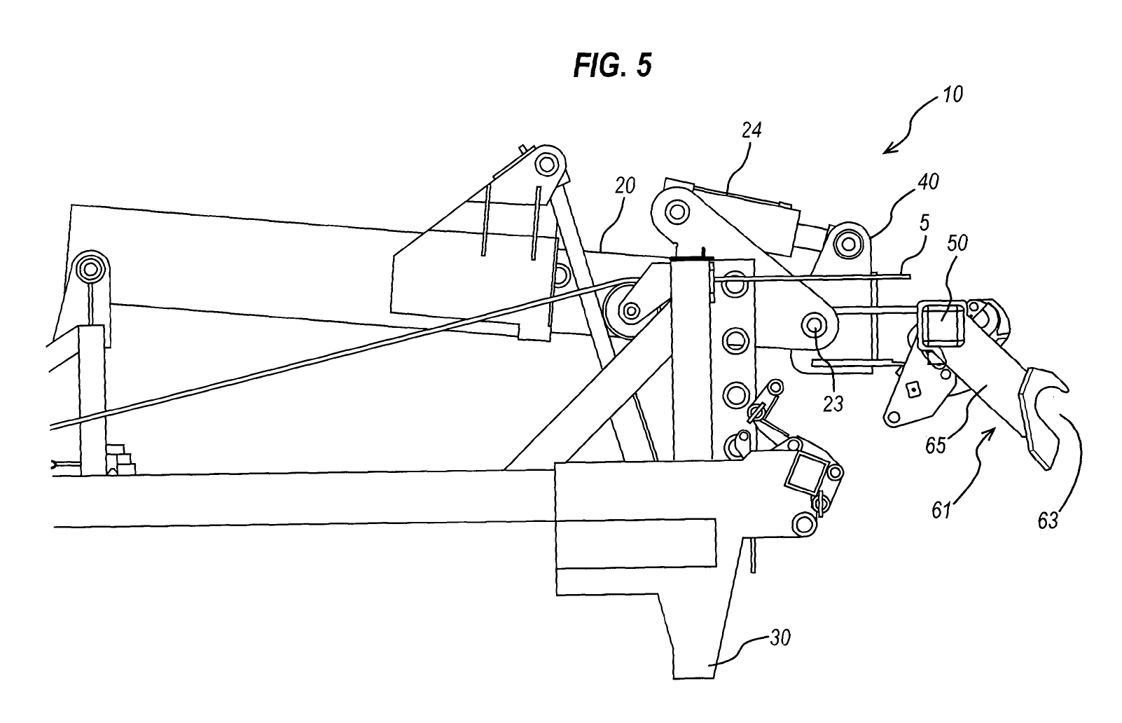

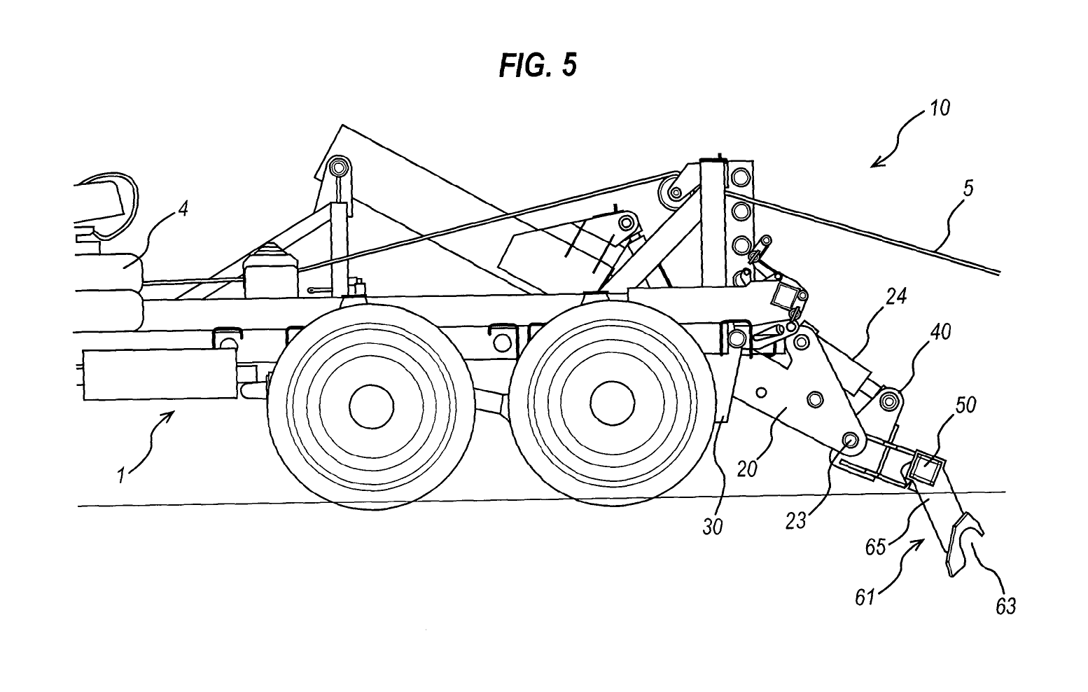

During a recovery operation, the spades (61, 62) are attached to the recovery bar (50) by sliding over ends (51, 52) as seen in FIG. 4. The moveable beam (20) is extended, and then the hydraulic system (24) rotates the bracket (40) and recovery bar (50) from the upright position as shown in FIG. 3A, away from the beam (20) to the fully extended position as shown in FIG. 3B, driving the recovery bar (50) towards the ground such that the spades (61, 62) engage the ground to stabilise the vehicle, as shown in FIG. 5. A winch rope (5) is then secured to the casualty vehicle (2), after which the winching apparatus (4) reels in the rope (5), and in so doing, drags the casualty vehicle (2) towards the recovery vehicle (1) along a rescue line. During this process, the spades (61, 62) prevent the recovery vehicle (1) from being pulled towards the casualty vehicle (2) as a reverse force is applied to the ground via the spades (61, 62). This winching operation is shown in FIG. 6.

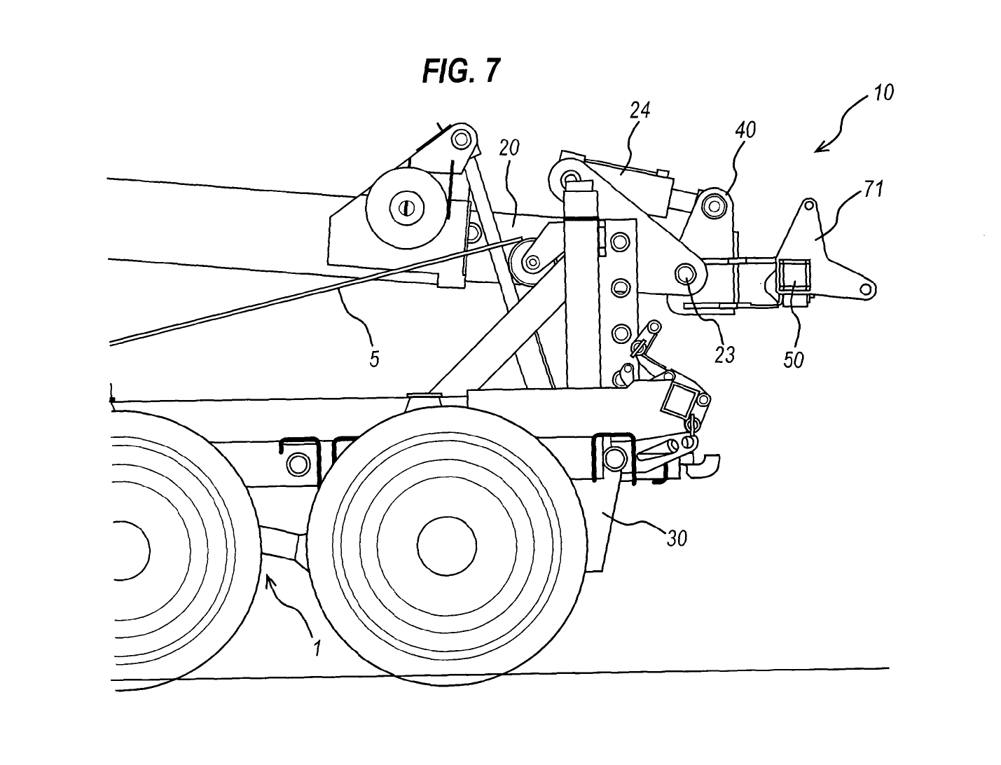

When the casualty vehicle (2) been extricated, the moveable beam (20) is raised to extract the spades (61, 62) from the ground. The spades (61, 62) are then removed from the ends (51, 52) of the recovery bar (50) and stowed on the vehicle. The tow adaptors (71, 72) are then attached to the recovery bar (50) to facilitate a towing operation as illustrated in FIG. 8. Here the partially recovered casualty vehicle (2) is attached to the recovery vehicle (1) via recovery bar (50) fitted with the tow adaptors (71, 72). This connection process is facilitated by raising or lowering or extending or retracting the moveable beam (20) by using the relevant hydraulic systems, or rotating the recovery bar (50) so as to bring the tow adaptors into line with the recovery eyes fitted to the partially recovered casualty vehicle (2) so that pins may be inserted. The moveable beam (20) is then raised to lift the partially recovered casualty vehicle (2) to the correct height for towing and retracted to set the correct distance between the recovery vehicle (1) and the partially recovered casualty vehicle (2). Pins are then inserted into the rear structure of the recovery equipment (10) so as to relieve the beam lifting hydraulic system of load. The altitude of the recovery bar (50) is then adjusted by the hydraulic system (24) so that second pivot bearing (41) operates in a truly horizontal plane so that the chassis of the partially recovered casualty vehicle (2) is relieved of twisting load when cornering. The recovery vehicle (1) then pulls away with the partially recovered casualty vehicle (2) and, in so doing, fully recovers it.

As mentioned above, the recovery bar (50) is unconstrained and swivels freely about the second pivot axis (41). This allows the recovery assembly (10) to engage the ground even in conditions where uneven ground surfaces (encountered in rough terrain) prevents the recovery bar (50) from being perfectly perpendicularly oriented to the beam (20).

As may be apparent from the above description, the depth at which the spades (61, 62) penetrate the ground greatly affects the stability of the rescue vehicle during the recovery operation. Thus the rescue vehicle (1) is preferably positioned on terrain that will facilitate penetration of the spades (61, 62) into the ground to provide adequate stability to the rescue vehicle (1) during a rescue operation.

Referring to FIG. 2, each spade (61, 62) includes an anchor portion (63, 64) attached to a support (65, 66) which may have a hollow interior in order to reduce weight. Each side of the support (65, 66) is formed with an aperture (67, 68) that mates with the shape of the rectangular recovery bar (50) to enable attachment and removal of the spades (61, 62) from the ends (51, 52) of the recovery bar (50).

Each anchor portion (63, 64) includes a generally planar plate that is fitted with anchor blades (63B, 63C, 64B, 64C) that extend substantially vertically from the surface of each planar plate (63A, 64A). This allows the anchor portion (63, 64) to angularly penetrate a ground surface at an anchor point, thereby generating a tractive (or frictional) force that prevents the rescue vehicle from moving during a rescue operation. More particularly, the anchor portion (63, 64) is inclined to the ground such that when a vehicle (2) is recovered, the forces involved tend to drive the spades (61, 62) further into the ground. This inclination may be optimised by altering the attitude of the recovery bar (50) by use of the hydraulic system (24).

The anchor blades (63B, 63C, 64B, 64C) are designed such that they cut into the ground when the spades (61, 62) are driven into the ground, thereby providing further friction and stability. The separation of the spades (61, 62) on the recovery bar (50) also improves the stability of the recovery vehicle (1) during a rescue operation.

Additionally, the anchor blades (63B, 63C, 64B, 64C) can be designed to have various profiles to increase the resulting tractive force. Such configurations can improve the effectiveness of the recovery spades (61, 62) in penetrating the ground to generate tractive (or frictional) force during rescue operations.

Only the preferred embodiments of the invention and but a few examples of its versatility are shown and described in the present disclosure. It is to be understood that the invention is capable of use in various other combinations and environments and is capable of changes or modifications within the scope of the inventive concept as expressed herein.

While this invention has been described in connection with what is presently considered to be the most practical and preferred embodiments, it is to be understood that the invention is not limited to the disclosed embodiments, but, on the contrary, is intended to cover various modifications and equivalent arrangements included within the scope of the appended claims.

1. A vehicle recovery assembly comprising:
a movable beam carrying a recovery bar,
wherein the bar carries at least one spade to enable recovery of a vehicle.

2. The vehicle recovery assembly of claim 1, wherein a bracket is connected to a distal end of the beam via a first pivot.

3. The vehicle recovery assembly of claim 2, wherein the bracket is connected to the recovery bar via a second pivot.

4. The vehicle recovery assembly of claim 2, wherein the first pivot enables rotation of the recovery bar about a first pivot axis.

5. The vehicle recovery assembly of claim 3, wherein the second pivot enables rotation of the recovery bar about a second pivot axis.

6. The vehicle recovery assembly of claim 1, wherein the at least one spade is removable.

7. The vehicle recovery assembly of claim 5, wherein the recovery bar rotates freely about the second pivot axis.

8. A vehicle recovery assembly comprising:
a beam, a proximal end of which is securable to the carriage of a vehicle; and
a bracket connected to a distal end of the beam via a first pivot enabling rotation of the bracket about a first pivot axis;
the bracket further connected to a recovery bar via a second pivot enabling rotation of the recovery bar about a second pivot axis.

9. The vehicle recovery assembly of claim 3, wherein the first pivot comprises a first pivot axis and wherein the second pivot comprises a second pivot axis, and wherein the first pivot axis and the second pivot axis are inclined to each other.

10. The vehicle recovery assembly of claim 2, wherein the bracket is rotated about the beam by hydraulic means.

11. The vehicle recovery assembly of claim 8, wherein the recovery bar rotates freely about the second pivot axis.

12. The vehicle recovery assembly of claim 8, wherein the recovery bar carries at least one spade for engaging the ground when the recovery bar is lowered during a winching operation.

13. The vehicle recovery assembly of claim 1, wherein the recovery bar carries at least one adaptor for engaging a casualty vehicle during a towing operation.

14. A recovery vehicle comprising the recovery vehicle assembly of claim 1.

15. (canceled)

16. A method of recovering a vehicle incorporating:
applying removable spades to a recovery bar;
driving the bar towards the ground such that the spades engage the ground;
applying a winch rope to a vehicle to be recovered; and
recovering the vehicle.

17. The method of recovering a vehicle of claim 16, further incorporating: removing the spades from the recovery bar;
applying towing adaptors to the recovery bar; and
fully recovering the vehicle.

18. The vehicle recovery assembly of claim 8, wherein the first pivot axis and the second pivot axis are inclined to each other.

19. The vehicle recovery assembly of claim 8, wherein the bracket is rotated about the beam by hydraulic means.

20. The vehicle recovery assembly of claim 9, wherein the recovery bar rotates freely about the second pivot axis.

21. The vehicle recovery assembly of claim 10, wherein the recovery bar carries at least one spade for engaging the ground when the recovery bar is lowered during a winching operation.

22. The vehicle recovery assembly of claim 8, wherein the recovery bar carries at least one adaptor for engaging a casualty vehicle during a towing operation.
